(19) United States
(12) Patent Application Publication
(10) Pub. No.: US 2012/0008323 A1
(43) Pub. Date: Jan. 12, 2012

(54) Speaker Illumination System and Method Therefor

(75) Inventors: John J. Lazzeroni, Tucson, AZ (US); Melinda K. Carevich, Tucson, AZ (US); Keith E. Overby, Tucson, AZ (US); James D. Vertz, Tucson, AZ (US)

(73) Assignee: J&M CORPORATION, Tucson, AZ (US)

(21) Appl. No.: 13/167,868

(22) Filed: Jun. 24, 2011

Related U.S. Application Data
(60) Provisional application No. 61/362,600, filed on Jul. 8, 2010.

(51) Int. Cl. F21V 33/00

(52) U.S. Cl. 362/253

(57) ABSTRACT

An illumination system for a speaker of a vehicle is provided. A speaker cone of the speaker has an opening defined by an outer perimeter of the speaker cone. The illumination system includes a housing configured to couple over the speaker cone. A first plurality of point light sources are mounted to the housing. The first plurality of point light sources are oriented towards the speaker cone when the housing is coupled over the speaker cone. A second plurality of point light sources are mounted to the housing. The second plurality of point light sources are oriented towards the speaker cone when the housing is coupled over the speaker cone. A control switch is in electrical communication with the first and second plurality of point light sources. The control switch is configured to selectively illuminate one of the first and second plurality of point light sources.

### CROSS-REFERENCE TO RELATED APPLICATIONS

This application claims priority to, and the benefit of, provisional U.S. Application Ser. No. 61/362,600, filed on Jul. 8, 2010, the entire contents of which are incorporated herein by reference.

### FIELD

Various implementations of the present invention, and combinations thereof, are related to speaker illumination systems, and, particularly, speaker illumination systems that use light sources to illuminate a speaker cone.

### BACKGROUND

Today, many vehicles include integrated audio systems for broadcasting sounds to one or more occupants of the vehicle. The audio systems include one or more speakers mounted throughout an interior or exterior of the vehicle. The speakers may includes woofers, subwoofers, or tweeters with the number, size, and placement of the speakers being at least partially determined by the complexity, size, cost, and performance requirements of the audio system.

Because the speakers of a stereo system can be delicate, they are often hidden behind protective screens, coverings, or grills. In woofers and subwoofers, for example, the cone portion of the speaker may be fabricated using delicate materials such as a stiff paper or plastic. If the cone becomes damaged, sounds generated by the speaker may be severely distorted. In cases of extreme damage, the speaker may not generate sound at all. These protective screens or coverings may be particularly important in applications where the speaker is mounted in an exposed position.

In the case of motorcycle and boat speaker systems, speakers may be mounted into or close to a fairing of the vehicle. A fairing is a structure mounted to or formed over an exterior of a vehicle for controlling air-flow over and around the vehicle. In some cases, the fairing protects vehicle users from wind flow or weather that would ordinarily be felt when the vehicle is traveling at relatively high speed. Fairings are often used as convenient locations for mounting both a vehicle's dashboard instruments and speakers, even though those locations may be exposed to the elements.

Generally, in a vehicle speaker installation, even though the speakers and dashboard instruments are mounted close to one another, the color and design of the speaker and any installed coverings or grills do not match those of the dashboard components of the vehicle. Many speaker coverings or grills are fabricated from black plastic, for example, while the dashboard instruments may include different colors and/or background or foreground illumination. In the case of after-market speaker installations, although the speaker and any coverings or grills may include different designs including different colors, the colors are unlikely to match those of the dashboard instruments.

The disconnect between speaker appearance and the dashboard instrumentation is particularly apparent at night when the dashboard instruments are illuminated. In most vehicles, the dashboard instruments are illuminated using colored lighting, with the color of the lighting being selected by the vehicle's manufacturer. In many cases, the color is determined based upon the vehicle model or upgrades present in the vehicle. In some cases, however, the illumination color is modified as part of an after-market upgrade or add-on. The speakers, however, are generally not illuminated and so do not contribute to the overall appearance of the dashboard and, if present, the fairing of the vehicle when the dashboard is otherwise illuminated.

Speaker illumination can confer several benefits. Further to the aesthetic benefits of matching the appearance of the speakers to the dashboard instrumentation or other lighted portions of the vehicle, illuminated speakers can be used to provide information. For example, in the case of police motorcycles or other emergency vehicles with exposed speakers, speaker illumination can be used to supplement existing lighting systems that can be used to warn others of a dangerous situation or to signal that a vehicle should pull over.

For private motorcycles, speaker illumination can be used in conjunction with other “hazard lighting” to warn others of mechanical problems or dangerous situations. The lighting also assists others in seeing the vehicle in poor lighting conditions thereby avoiding potential collisions or other accidents. This may be particularly important, for example, in nighttime boating applications.

Several existing speaker illumination systems have been developed. Generally, these systems require that a light source such as a light tube or other lighting structure be fixed to the speaker. The light sources are generally configured so that a majority of the light generated by the light source is transmitted directly outwards from the speaker. This configuration allows a maximal amount of light generated by the light sources to be emitted from the speaker housing providing, presumably, the greatest effect.

These existing speaker lighting configurations, however, have several problems. First, because a majority of the light generated by the enclosed light source is transmitted directly from the light source out of the speaker housing, the light can be disruptive to a driver or passenger because the light source can create significant glare. In the case of point light sources, for example, where the light generated by the light source is concentrated into a single point source or series of point sources, if a vehicle user should happen to glance at the speaker and the point light sources disposed therein, the user may be partially blinded or distracted making it difficult for the user to operate the vehicle. The user's night vision may also be negatively affected, especially given light sources of particular colors. Interrupting a user's night vision may be particularly detrimental and, consequently, dangerous in boating or off-road applications, for example, where a navigator must use his or her night vision to avoid obstacles.

Finally, in existing after-market speaker illumination systems, the provided colors may not match those of the dashboard illumination. In newer automotive applications, for example, where the color of dashboard illumination may be adjusted, existing speaker illumination systems do not allow for similar adjustment in the color of illumination.

Accordingly, there exists a need for a vehicle speaker illumination system that allows for the light generated by the illumination system to be configurable to optionally match or compliment an existing illumination color of one or more dashboard instrument of the vehicle. There also exists a need for a speaker illumination system that does not operate as a source of light that is particularly distracting or blinding to an operator of the vehicle.

### SUMMARY

In one embodiment, the present invention is an illumination system for a speaker of a vehicle. The speaker includes a speaker cone. The speaker cone has an opening defined by an outer perimeter of the speaker cone. The illumination system comprises a housing configured to couple over the opening of the speaker cone, and a first plurality of point light sources mounted to the housing. The first plurality of point light sources are oriented towards the speaker cone when the housing is coupled over the speaker cone. The system includes a second plurality of point light sources mounted to the housing. The second plurality of point light sources are oriented towards the speaker cone when the housing is coupled over the speaker cone. The system includes a control switch in electrical communication with the first and second plurality of point light sources. The control switch is configured to selectively illuminate one of the first and second plurality of point light sources.

In another embodiment, the present invention is an illumination system for a speaker. The speaker includes a speaker cone. The speaker cone has an opening defined by an outer perimeter of the speaker cone. The illumination system comprises a housing configured to mount above the opening of the speaker cone. The housing includes a printed circuit board (PCB). The PCB is configured to be disposed between the outer perimeter of the speaker cone and a speaker covering. The system includes a plurality of point light sources coupled to a first surface of the housing, and a control switch in electrical communication with the plurality of point light sources. The control switch is configured to selectively illuminate the plurality of point light sources.

In another embodiment, the present invention is an illumination system for a speaker. The illumination system comprises a housing configured to couple over the speaker, and a plurality of light sources coupled to the housing. The plurality of light sources are positioned on the housing so that a majority of light generated by the plurality of light sources is reflected from a surface of the speaker when the housing is mounted above the speaker and the plurality of light sources are illuminated. The system includes a control switch in electrical communication with the plurality of point light sources. The control switch is configured to selectively illuminate the plurality of light sources.

In another embodiment, the present invention is a method of illuminating a speaker cone. The speaker cone has an outer perimeter. The method comprises providing a housing configured to mount above the opening of the speaker cone. The housing includes a first plurality of point light sources coupled to the housing. The first plurality of point light sources are oriented towards the speaker cone when the housing is mounted above the opening of the speaker cone. The housing includes a second plurality of point light sources mounted to the housing. The second plurality of point light sources are oriented towards the speaker cone when the housing is mounted above the opening of the speaker cone. The housing includes a control switch in electrical communication with the first and second plurality of point light sources. The control switch is configured to selectively illuminate one of the first and second plurality of point light sources. The method includes disposing the housing above the opening of the speaker cone, and using the control switch to selectively illuminate one of the first and second plurality of point light sources.

### BRIEF DESCRIPTION OF THE DRAWINGS

Implementations will become more apparent from the detailed description set forth below when taken in conjunction with the drawings, in which like elements bear like reference numerals.

FIGS. 1a and 1b are illustrations of an exemplary vehicle speaker installation incorporating the present speaker illumination system, the figures illustrate the system in an exploded view, showing how each of the major components of the system may be mounted to one another;

FIG. 2 is an illustration of an exemplary electrical power interconnection for the speaker illumination system;

FIG. 3 is an illustration of an exemplary vehicle speaker installation incorporating the present speaker illumination system and including a speaker adapter for fitting the housing of the speaker illumination system to a speaker;

FIG. 4 is an illustration of a housing of a speaker illumination system in accordance with the present disclosure, the housing includes a planar structure configured to be disposed between a speaker and a speaker grill or covering;

FIG. 5 is a cross-sectional view of an example speaker having a speaker cone, with the housing of the speaker illumination system mounted over the speaker cone; and

FIG. 6 is an illustration of an exemplary electrical interconnection network for the light sources and control circuit of the present speaker illumination system.

### DETAILED DESCRIPTION

The present invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present system and method provides a speaker illumination system. The system may be configured to selectively illuminate one or a plurality of light sources for illuminating a speaker cone. In some cases, the light sources may include a plurality of point light sources, as described below. The system can be used to modify an appearance of the speaker to conform to an aesthetic appearance of a vehicle's dashboard instrumentation. For example, in some applications, the light sources may be selectively illuminated to output different colors or combinations of colors to provide aesthetic compatibility with existing dashboard illumination. In other applications, the speaker illumination system may be configured to communicate information such as the existence of an emergency or hazard condition.

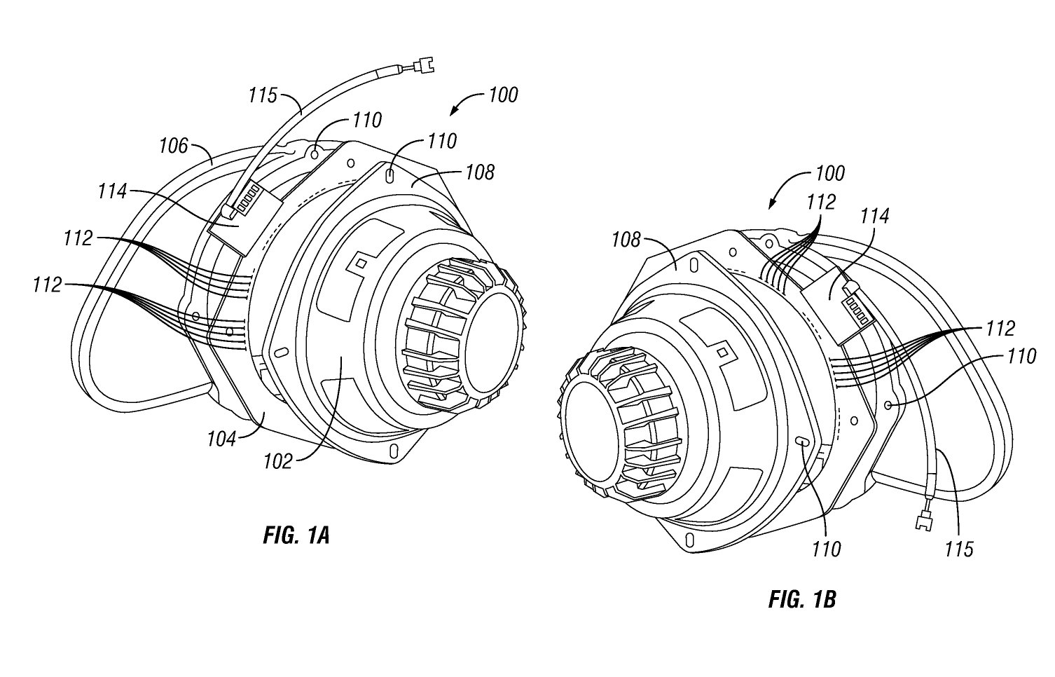

FIGS. 1a and 1b are illustrations of an exemplary vehicle speaker installation incorporating the present speaker illumination system. Both FIGS. 1a and 1b illustrate the system in an exploded view, showing how each of the major components of the system may be mounted to one another. Speaker system 100 includes speaker 102, speaker illumination system housing 104, and speaker covering 106. Speaker 102 includes a speaker cone or diaphragm (not shown) that is mounted to a rigid frame 108 of the speaker 102 via a flexible connection. An electro-mechanical driver is mounted within frame 108 to drive the speaker cone to generate sound. The electro-mechanical driver may be connected, for example, to an output stage of an audio amplifier.

Speaker covering 106 is mounted over housing 104 to speaker 102. Speaker covering 106 may include any appropriate material such as plastics or metals for protecting speaker 102 and is generally configured to be aesthetically appealing. For example, if speaker system 100 is to be mounted within a recess or opening formed within a fairing or dashboard of a vehicle, speaker covering 106 is configured to cover the recess to generate a “finished” look.

Housing 104 is configured to mount within speaker system 100 between speaker covering 106 and speaker 102. In one implementation, each of speaker 102, housing 104 and speaker covering 106 may include holes 110 that may be aligned for mounting each of the components to a vehicle. For example, a bolt may be threaded through holes 110 and into a portion of the vehicle for mounting speaker system 100 into the vehicle. In other implementations, however, any suitable fastener may be used to mount speaker 102, housing 104 and speaker covering 106 together and to fix speaker system 100 to a portion of a vehicle.

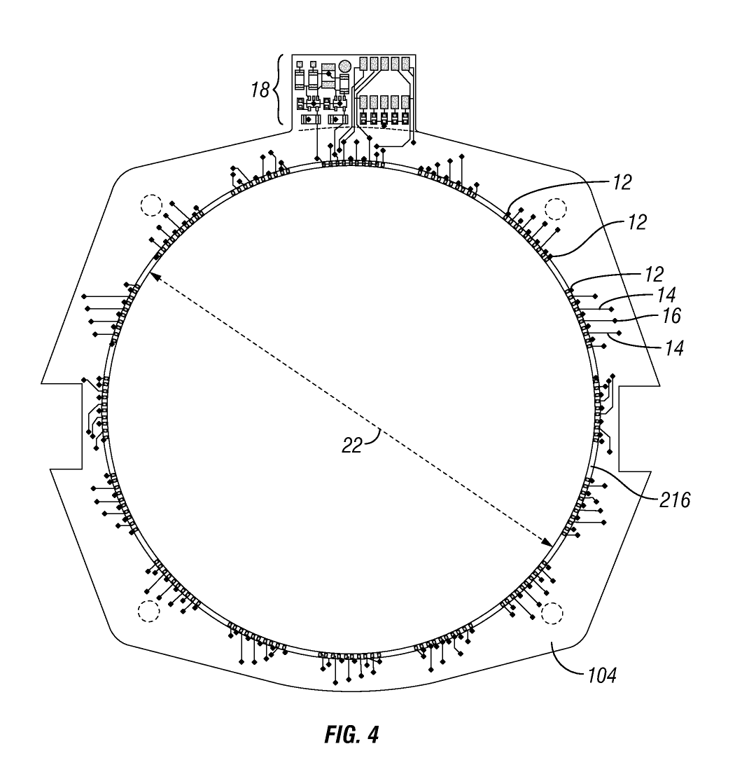

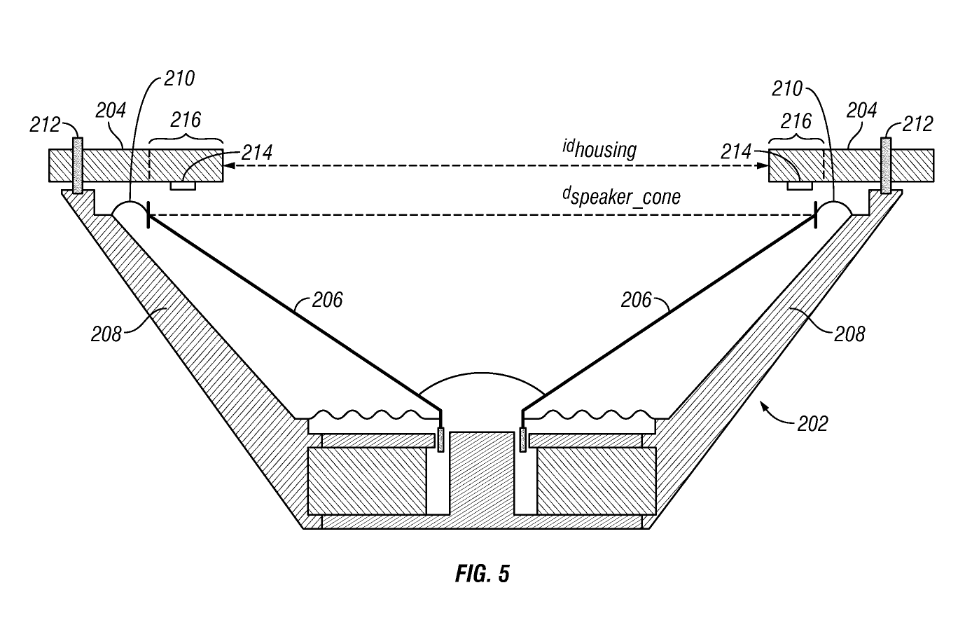

Housing 104 includes a plurality of light sources 112 mounted over a first surface of housing 104. When housing 104 is mounted to speaker 102, light sources 112 of housing 104 are oriented towards the speaker cone of speaker 102. In that configuration, housing 104 is sized so that the interior portion of housing 104 over which light sources 112 are mounted falls within a volume defined by the speaker cone of speaker 102. Accordingly, when housing 104 is mounted to speaker 102, any light emitted from light sources 112 is not blocked by housing 108 or any other structures of speaker 102 and is free to be reflected from a surface of the speaker cone. Housing 104 includes an opening formed in a central region of housing 104 to allow light reflected from a surface of the speaker cone to pass through housing 104 and exit speaker system 100. Further information describing the geometry of housing 104 is provided below with reference to FIGS. 4 and 5.

Housing 104 includes a control circuit 114 for controlling the illumination of light sources 112. Depending upon the system implementation, control circuit 114 may be configured to selectively illuminate one or more of light sources 112. In some cases, control circuit 114 is further configured to determine an output color of light sources 112. For example, where each of light sources 112 are individually capable of outputting two or more colors, control circuit 114 may be configured to determine the output color of each of light sources 112. Control circuit 114 may provide a user interface such as a knob or switch to allow a vehicle user to control the lighting configuration of light sources 112 and may be electrically connected to one or more data processing unit to control a configuration of light sources 112 automatically.

Power cord 115 provides electrical energy to light sources 12. Power cord 115 is connected to control circuit 114 and, thereby, light sources 112. Power cord 115 is configured to connect to an appropriate source of electrical energy for illuminating one or more of light sources 112. Depending upon the system implementation, power cord 115 may be configured to connect to electrical connections on a cigarette lighter, or other power source within the vehicle.

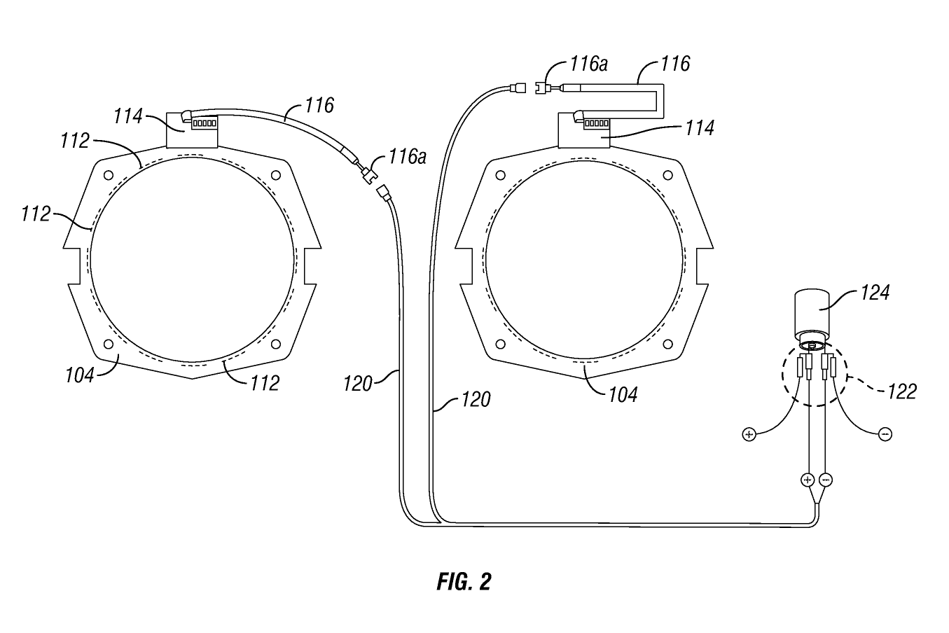

FIG. 2 is an illustration of an exemplary electrical power interconnection for housing 104. Housing 104 includes control circuit 114 that is, in turn, connected to power cord 116. Power cord 116 includes connectors 116a that are configured to mechanically and electrically interconnect with extension wires 120. Extension wires 120 includes additional connectors 122 that are configured to interconnect with a vehicle's cigarette lighter, for example. In this example, the cigarette lighter acts as a source of electrical energy to power light sources 112 affixed to housing 104. In other implementations of the present system, however, control circuit 114 is connected to any appropriate source of electrical energy through power cords 116.

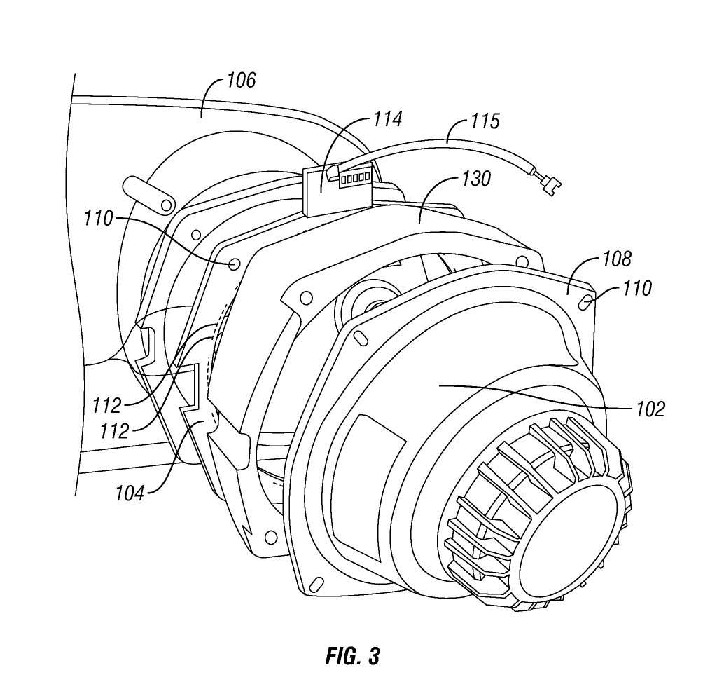

FIG. 3 is an illustration of an exemplary vehicle speaker installation incorporating the present speaker illumination system and including a speaker adapter 130 for fitting housing 104 to speaker 102. FIG. 3 illustrates the system in an exploded view, showing how each of the major components of the system mount to one another. Speaker system 100 includes speaker 102, speaker illumination system housing 104, and speaker covering 106. In this illustration, however, the diameter of housing 104 is not compatible with a diameter of speaker 102 and, as such, housing 104 cannot be mounted directly to a face of speaker 102. Accordingly, adapter 130 is disposed between speaker 102 and housing 104 to enable housing 104 to be mounted to speaker 102. Adapter 130 may be constructed out of any suitable rigid material including plastics, and metals. In the example shown in FIG. 3, speaker covering 106 may also be sized to couple to speaker adapter 130.

FIG. 4 is an illustration of the housing 104 of speaker illumination system 100. In this implementation, housing 104 includes a planar structure configured to be disposed between speaker 102 and speaker covering 106 (as illustrated, for example, in FIGS. 1a and 1b). Accordingly, housing 104 may be configured to operate in the manner of a gasket disposed between the speaker and housing. Housing 104 may include surface treatments or coverings to establish a seal between the housing 104 and speaker 102 to prevent the passage of water or other material between the housing and speaker. As shown in FIG. 4, housing 104 may include a printed circuit board (PCB). The PCB provides a general substrate for structural support and electrical interconnect of various devices mounted to the PCB.

A plurality of point light sources 12 are mounted over a first surface of housing 104. Light sources 12 may include light emitting diodes (LEDs) that are surface mounted to housing 104. In the surface mounted configuration, light sources 12 are connected to contact pads formed over a surface of housing 104 using a conductive solder material. The solder material may be deposited as a paste over the PCB using a solder deposit process such as screen printing. Light sources 12 are then pick-and-placed over the solder material.

The PCB with mounted lights sources 12 enters a solder reflow process. During solder reflow, the PCB, light sources 12 and solder paste are heated to a temperature sufficient to cause reflow of the solder contained with the solder paste. After reflow, a mechanical and electrical connection is established between the PCB and light sources 12. The PCB and mounted components may then be washed to remove any flux residue or stray solder material that may have accumulated during the reflow process. Other mounting techniques such as through-hole mounts may also be used to mount light sources 12 to housing 104.

Light sources 10 may include a plurality of LEDs, with each LED emitting one or more different colors. For example, one-third of light sources 10 may emit a red color, one-third a green color, and one-third a blue color. Alternatively, each light source 12 may be configured to emit two or more colors of light. For example, light sources 12 may include one or more multi-colored LED device. Alternative light sources 12 include incandescent light bulbs, electroluminescent wire, organic light emitting diodes (OLEDs), polymer light emitting diodes (PLEDs), or any other light sources configured to be mounted to housing 104.

In one implementation, light sources 12 include point light sources. In that case, light sources 12 generally include a plurality of independent light sources that may be mounted around housing 104. In this cases, point light sources are light sources that have a small size relative to the geometry of housing 104 and system 100. For example, in one implementation where light sources 12 include surface-mounted LEDs, the size of each of light sources 12 is approximately 0.8 millimeters (mm) by 0.8 mm. Alternatively, light sources 12 may have a significant larger size, or include continuous light sources that form a ring, or a portion of a ring, running along a surface of housing 104. For example, if the light source includes electroluminescent wire or a fluorescent tube, light sources 12 may be replaced with a single light source that is mounted along a surface of housing 104. The single light source may be disposed around a portion of housing 104 to provide a source of illumination running along a majority of housing 104.

Light sources 12 may be electrically interconnected using a plurality of conductive traces 14 formed over one or more surfaces of housing 104. Conductive traces 14 may be formed on a surface or within layers of PCB 12 using evaporation, electrolytic plating, electroless plating, screen printing, or other suitable metal deposition process. Traces 14 provide power and ground connections to each of light sources 12. Conductive through-holes 16 penetrate to a second surface of housing 104 and electrically connect conductive traces 14 to the second surface of housing 104. Additional circuitry may then be formed over the second surface of housing 104 or within housing 104 to further interconnect light sources 12 with other system components.

Light sources 12 are also connected to control circuit 18 using conductive traces 14. Control circuit 18 includes a plurality of electrical switches that are in communication with one or more of light sources 12, a power source, and ground. Depending upon a configuration of control circuit 18, control circuit 18 can selectively illuminate one or more of light sources 12. If one or more of light sources 12 are configured to individually emit two or more different colors, control circuit 18 is configured to select one or more color to be emitted by each of light sources 12.

Control circuit 18 is connected to any appropriate user interface. For example, control circuit 18 may be connected to a rotary switch, toggle switch, or other selector switch for controlling an operation of control circuit 18 and, thereby, an illumination of one or more of light sources 12. Alternatively, control circuit 18 may be electrically connected to a switch or electrical circuit than controls dashboard illumination. The system that controls dashboard illumination may include a light-detection sensor or a manual selector switch for controlling dashboard illumination. Additional dimmer or brightness-control circuits may be integrated into the control system.

In some implementations of the illumination system, control circuit 18 is also connected to a computer or processor that is configured to control the illumination of light sources 12 in accordance with a pre-determined algorithm or program. The computer or processor may interface with an audio system of the vehicle to allow the sound generated by such a system to control the illumination of light sources 12. For example, the processor may implement an algorithm to determine a beat or other musical characteristic of sound generated by the audio system, and then use that beat or characteristic to illuminate light sources 12 accordingly, such as by flashing or throbbing light sources 12.

Control circuit 18 may include a first selector switch or combination of switches to select an output color of light sources 12 and a second switch for controlling whether power is supplied to each of light sources 12. In some implementations, control circuit 18 also includes power control circuitry to ensure that each one of light sources 12 receives an appropriate supply of electrical energy during illumination.

FIG. 5 provides further illustration of the geometry of the housing of the speaker illumination system mounted over a speaker. FIG. 5 is a cross-section view of an example speaker 202 showing housing 204 mounted thereover. As shown in FIG. 5, speaker 202 include speaker cone 206. Speaker cone 206 is connected to a frame 208 of speaker 202 via flexible coupling 210. Housing 204 is physically connected to frame 208 of speaker 202 using fastener 212. Light sources 214 are mounted of a front surface of housing 204 and are oriented towards speaker cone 206 when housing 204 is mounted to speaker 202.

As illustrated in FIG. 5, housing 204 is configured so that light sources 214 can shine light upon a surface of speaker cone 206 without being obstructed by flexible connection 210 or frame 208 of speaker 202. Accordingly, when speaker cone 206 has an exterior perimeter with diameter dₛₚₑₐₖₑᵣ_{_{—}}_{cone}, housing 204 may be sized so that the region of housing 204 over which light sources 214 are mounted 216 (see, also, FIG. 4) falls within dₛₚₑₐₖₑᵣ_{_{—}}_{cone}. Accordingly, an inner diameter of housing (id_{housing}) is less then dₛₚₑₐₖₑᵣ_{_{—}}_{cone}. In other implementations, however, such as when housing 204 is mounted further away from the speaker cone (such as when a speaker adapter is disposed between the housing and speaker as illustrated in FIG. 3), housing 204 may be significantly larger. In that case, it is only necessary that when the housing is mounted to the speaker, that the light sources be mounted within the conic volume defined by the speaker cone. Accordingly, as shown in FIG. 5, when housing 204 is mounted to speaker 202, light sources 214 are disposed within the volume defined by the cone of speaker 202 and are oriented towards speaker 202. Accordingly, when light sources 214 are illuminated, light generated by light sources 214 is transmitted towards a surface of speaker 202. The light is then reflected from the surface of speaker 202 and exits the speaker system through the interior opening (shown in FIG. 4 as element 22 of housing 104) of housing 204.

Referring back to FIG. 5, area 216 of housing 104 may have different geometrical configurations from that illustrated. For example, in place of the ring geometry illustrated in FIG. 4, area 20 may include a series of inward projections upon which light sources 12 are mounted. Accordingly, an inner perimeter of area 216 may have a saw-tooth or wave configuration with each projection having one or more light sources 12 mounted thereon. In some cases, the projections may be random or configured to provide a particular visual effect. Similarly, housing 104 may include a plurality of struts that extend through a central region of housing 104. The struts may lay along a diameter or radius of housing 104, be chords that do not pass through a geometrical center of housing 104, or a combination thereof. In such a configuration, light sources 12 may be mounted upon the struts and oriented towards speaker 102 when housing 104 is mounted to speaker 104.

Housing 104 may also include one or more openings formed within or around a central region of housing 104 to allow light reflected from a surface of speaker 102 to pass through housing 104 and exit speaker system 100. To provide environmental protection, the openings may be covered with transparent or translucent materials such as glass, plastic, or other materials that allow a portion of light energy generated by light sources 12 to pass through. In some cases, the transparent or translucent materials may be configured to generate a particular visual effect, such as by including lenses or materials to change a color, focus, or other characteristics of the light. For example, each of the openings may be covered with a different material to adjust the color of light passing through each opening.

In some implementations of the present system, housing 104 is integrated into a speaker covering or grill that is configured to mount over a surface of speaker 102. For example, with reference to FIGS. 1a and 1b, speaker covering 106 may be formed integrally with housing 104. In that case, during construction of the speaker covering, the housing may be mounted separately or integrated into the speaker covering. Light sources may then be mounted over a surface of the speaker covering. A control circuit may then be mounted directly to the speaker covering, or otherwise electrically connected to the speaker covering and electrically interconnected with the light sources mounted to the housing portion of the speaker covering.

In some implementations of the present system, after fabrication, housing 104, control circuit 18, and conductive traces 14 are encapsulated to provide weatherization protection and electrical isolation. The encapsulation may include any appropriate insulating material such as resins like polyurethane resin or epoxy resin. The encapsulation provides for electrical and mechanical isolation of housing 104 and the components that are mounted to housing 104, but is generally not formed over light sources 12 to ensure that each of light sources 12 is able to efficiently output light. However, any electrical connections formed between conductive traces 14 and light sources 12 may be protected using the encapsulant. In some cases, the encapsulant may include a transparent material that is formed over light sources 12.

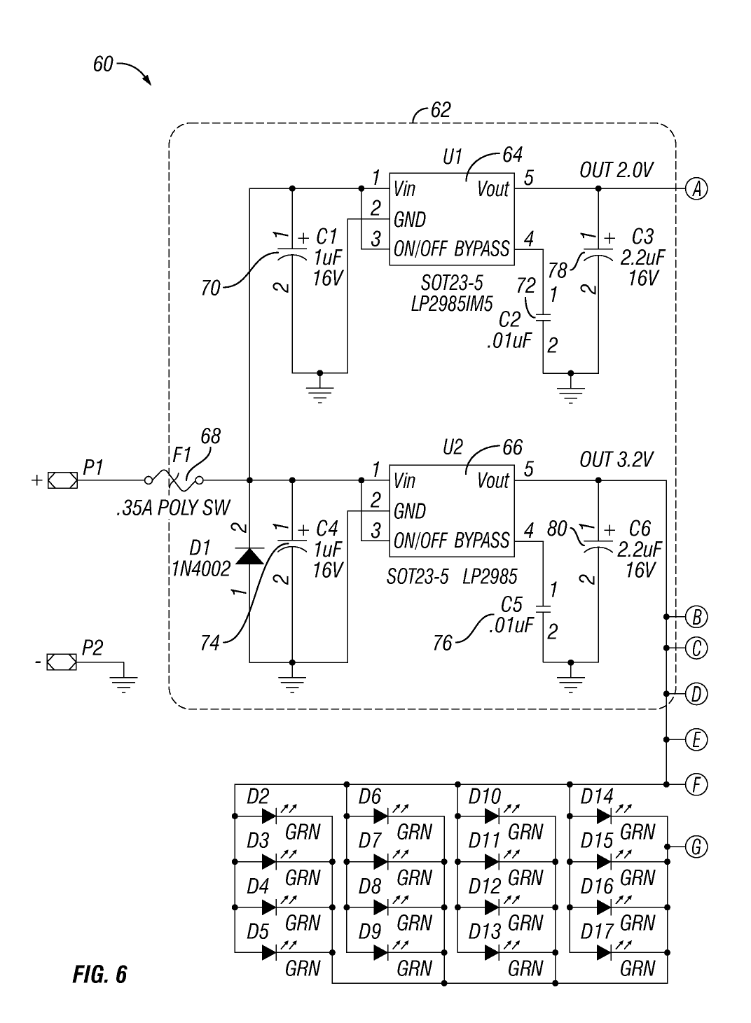

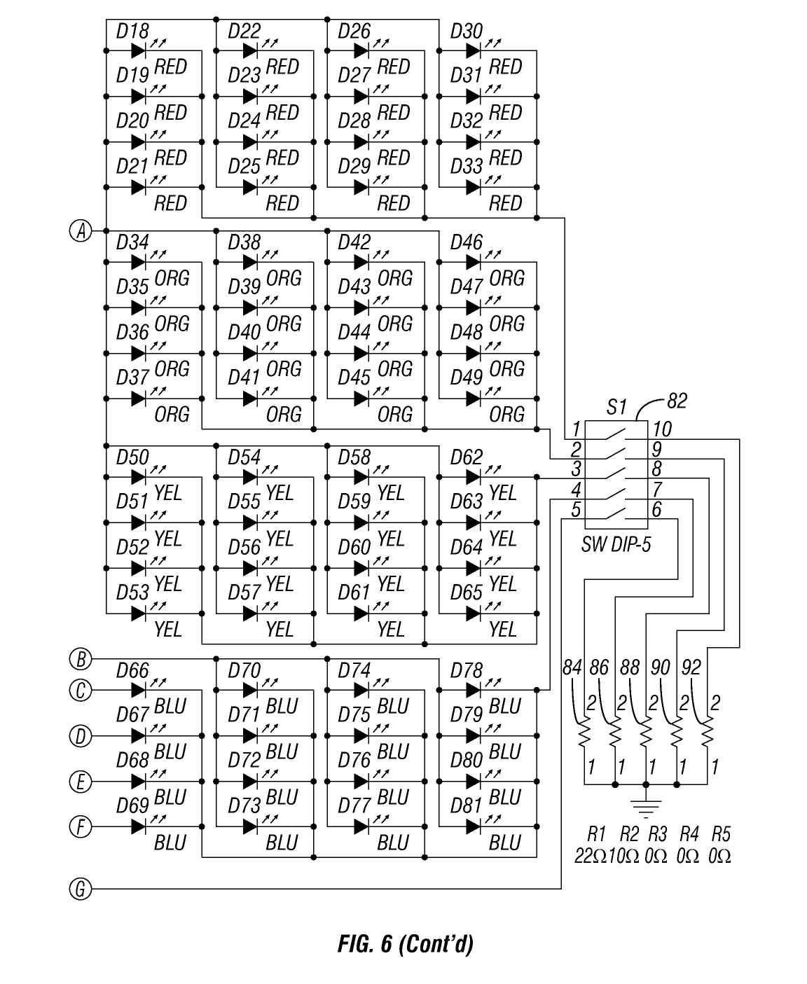

FIG. 6 is an illustration of an exemplary electrical interconnection network for the light sources and control circuit of the present speaker illumination system. Network 60 includes a plurality of LEDs (indicated by D2-D81) that operate as the light sources for the speaker illumination system that may be mounted over housing 104 (see FIG. 4, for example). LED D1 operates to provide a notification of whether the system is powered.

Electrical network 60 includes a power-regulation circuit 62 for supplying electrical energy to LEDs D2-D81. Regulation circuit 62 includes two separate regulator chips that are configured to supply power at different electrical voltages. The regulators may include LP2985 Micropower 150 mA Low-Noise Regulators in SOT-23 and micro SMD Packages manufactured by National Semiconductor, for example. In this implementation, regulator 64 is configured to generate an electrical energy source at a voltage of approximately 2.0V and regulator 66 is configured to generate an electrical energy source at a voltage of approximately of 3.2V. Because different LEDs may require different source voltages to operate, the energy generated by either regulator 64 or regulator 66 can be used to supply electrical energy to different collections of LEDs 2-81

Regulator circuit 62 also includes low-pass filters provided by capacitors 70, 74, 78 and 80 to remove high-frequency noise from the supplied electrical energy. Capacitors 72 and 76 operate as filters to remove noise from any bypass signal generated by regulators 64 or 66. LED D1 is connected to the power supply through switch 68 and is illuminated when power is supplied to the system.

Each of regulators 64 and 66 are connected to power supply P1 through switch 68. Switch 68 controls the power supply for electrical network 60 and may be connected to a manual switch operated by a user of the system, or an automatic switch connected to one or more electrical system of a vehicle, for example.

LEDs D2-D81 include a plurality of LEDs each supplying a different color. LEDs D2-D17 include green LEDs, LEDs D18-D33 include red LEDs, LEDs D34-D49 include orange LEDs, LEDs D50-D65 include yellow LEDs, and LEDs D66-D81 include blue LEDs. Because LEDs of different colors require different electrical power supplies to operate, each collection of LEDs may be supplied with electrical energy from regulator 64 or 66. Furthermore, by connecting each collection of LEDs in an electrical network having a particular number of LEDs in parallel in combination with a number of LEDs in series, the required input voltage for the entire collection or network of each color of LEDs can be controlled.

In this example, the green LEDs (LEDs D2-D17) are connected as 4 separate groups of LEDs connected in series, with the groups of series-connected LEDs being connected in parallel. In that configuration, the required input voltage for the green LEDs to operate, in combination with resistor 84, is approximately 3.2V. Accordingly, the green LEDs are connected to regulator 66 as a power supply. In contrast, a network of orange LEDs in the same series-parallel configuration in combination with resistor 90 requires an input voltage of approximately 2.0V to operate. Accordingly, the orange LEDs are connected to regulator 64.

To allow a single color of LEDs to be illuminated at a particular time, LEDs D2-D81 are connected to switch 82. As shown in FIG. 6, switch 82 may include a dual in-line package (DIP) switch, however any other switches suitable for controlling the flow of electricity may be used. Depending upon its configuration, switch 82 may connect a single one of the color groupings of LEDs to ground, through an optional resistance, allowing that color of LED to be illuminated.

A user can use switch 82 to manually control the color of light generated by the speaker illumination system. Alternatively, switch 82 may be coupled to a controller system, such as a computer or processor, to automatically modify switch 82 to control a light output color of the system. In some cases, switch 82 may be configured to illuminate more than one color grouping of LEDs at a particular time. Accordingly, the different colors of LEDs may be combined with one another to generate more colors than those made available by the LEDs individually.

One or more resistors (e.g., resistors 84, 86, 88, 90 and 92) may be coupled between switch 82 and ground to further control the supply voltage provided to each of the LEDs. As the resistance value of resistors 84, 86, 88, 90 or 92 increases, the voltage applied to the connected LED network decreases.

The present system provides an improved speaker illumination system. The illumination system can be configured and modified or adjusted using a control circuit. The control circuit is in electrical communication with each of a plurality of light sources mounted within the illumination system. The control circuit may interface with one or more switches that can be used by an operator to control a color and a power supply for each of the plurality of light sources.

Alternatively, the control circuit may interface with one or more electrical circuits that are configured to automatically control an illumination and color of the light sources. For example, in a vehicle having one or more light sensors to control the headlights and/or dashboard instrumentation of the vehicle, the control circuit may be connected to the light sensor. Accordingly, when the light sensor detects a low light level and illuminates the headlights and dashboard, the present speaker illumination system may also be illuminated. In some cases, the control circuit may be connected to both manual and automatic controls allowing for a user to over-ride the automatic system.

The operation of the speaker illumination system may be controlled by a computer or processor operating in accordance with a pre-determined algorithm. For example, the color generated by the system may be determined by time of day or whether hazard lights on a vehicle are currently operating. Output from one or more electrical systems within the vehicle such as a radio, music player, intercom, etc. may also be used as an input to control an operation of the illumination system.

In the present system, the light sources may include a plurality of point light sources and in one implementation the light sources include multi-color LEDs. The LEDs can be mounted to a housing or speaker covering or grill. If mounted to a housing, the housing is configured to be mounted over the speaker with the light sources being oriented toward to the speaker cone. The housing is shaped to allow the light sources to illuminate a central region of the speaker. The housing also includes one or more internal openings to allow light reflected from the speaker surface to pass through the housing. Accordingly, light reflect of the speaker surface passes through the housing and exits the speaker system.

Because the light generated by the present speaker illumination is reflected from the surface of the speaker, the light is generally dispersed by the surface of the speaker. Unlike the case of direct light sources that can be blinding or distracting, the present system can be safe for applications such as in night-driving or boating, where an operator's night-vision is important for safety reasons.

While one or more embodiments of the present invention have been illustrated in detail, the skilled artisan will appreciate that modifications and adaptations to those embodiments may be made without departing from the scope of the present invention as set forth in the following claims.

What is claimed is:

1. An illumination system for a speaker of a vehicle, the speaker including a speaker cone, the speaker cone having an opening defined by an outer perimeter of the speaker cone, the illumination system comprising:
a housing configured to couple over the opening of the speaker cone;
a first plurality of point light sources mounted to the housing, the first plurality of point light sources being oriented towards the speaker cone when the housing is coupled over the speaker cone;
a second plurality of point light sources mounted to the housing, the second plurality of point light sources being oriented towards the speaker cone when the housing is coupled over the speaker cone; and
a control switch in electrical communication with the first and second plurality of point light sources, the control switch being configured to selectively illuminate at least one of the first and second plurality of point light sources.

2. The system of claim 1, wherein the speaker cone is configured to mount to a fairing of a vehicle.

3. The system of claim 1, wherein the first and second plurality of point light sources include light emitting diodes (LEDs).

4. The system of claim 1, wherein the first plurality of point light sources is configured to output a first color and the second plurality of point light sources is configured to output a second color.

5. The system of claim 1, wherein the housing includes a gasket configured to be disposed between the outer perimeter of the speaker cone and a speaker covering.

6. The system of claim 5, wherein the housing includes a printed circuit board, and wherein the first and second plurality of point light sources are electrically connected to the control switch using conductive traces.

7. An illumination system for a speaker, the speaker including a speaker cone, the speaker cone having an opening defined by an outer perimeter of the speaker cone, the illumination system comprising:
a housing configured to mount above the opening of the speaker cone, the housing including a printed circuit board (PCB), the PCB being configured to be disposed between the speaker cone and a speaker covering;
a plurality of point light sources coupled to a first surface of the housing; and
a control switch in electrical communication with the plurality of point light sources, the control switch being configured to selectively illuminate the plurality of point light sources.

8. The system of claim 7, wherein the speaker cone is configured to mount to a fairing of a vehicle.

9. The system of claim 7, wherein the plurality of point light sources include light emitting diodes (LEDs).

10. The system of claim 9, wherein the LEDs include at least one multi-color LED.

11. The system of claim 7, wherein each of the plurality of point light sources is configured to output a first and second color, the control switch being configured to selectively illuminate the plurality of point light sources using at least one of the first and second color.

12. The system of claim 11, wherein the plurality of point light sources are electrically connected to the control switch using conductive traces.

13. An illumination system for a speaker, the illumination system comprising:
a housing configured to couple over the speaker;
a plurality of light sources coupled to the housing, the plurality of light sources being positioned on the housing so that a majority of light generated by the plurality of light sources is reflected from a surface of the speaker when the housing is mounted above the speaker and the plurality of light sources are illuminated; and
a control switch in electrical communication with the plurality of point light sources, the control switch being configured to selectively illuminate the plurality of light sources.

14. The system of claim 13, the plurality of light sources includes a plurality of point light sources.

15. The system of claim 13, wherein the speaker is configured to mount to a fairing of a vehicle.

16. The system of claim 13, wherein the plurality of light sources include light emitting diodes (LEDs).

17. The system of claim 13, wherein the plurality of light sources is configured to selectively output a first and second color and the control switch is configured to selectively illuminate the plurality of light sources with one of the first and second color.

18. The system of claim 13, wherein the housing includes a gasket configured to be disposed between the outer perimeter of the speaker and a speaker covering.

19. The system of claim 13, wherein the housing includes a printed circuit board, and wherein the plurality of light sources are electrically connected to the control switch using conductive traces.

20. A method of illuminating a speaker cone, the speaker cone having an outer perimeter, the method comprising:
providing a housing configured to mount above the opening of the speaker cone, the housing including:
a first plurality of point light sources coupled to the housing, the first plurality of point light sources being oriented towards the speaker cone when the housing is mounted above the opening of the speaker cone,
a second plurality of point light sources mounted to the housing, the second plurality of point light sources being oriented towards the speaker cone when the housing is mounted above the opening of the speaker cone, and
a control switch in electrical communication with the first and second plurality of point light sources, the control switch being configured to selectively illuminate one of the first and second plurality of point light sources;
disposing the housing above the opening of the speaker cone; and
using the control switch to selectively illuminate one of the first and second plurality of point light sources.

21. The method of claim 20, wherein the speaker cone is configured to mount to a fairing of a vehicle.

22. The method of claim 20, wherein the first and second plurality of point light sources include light emitting diodes (LEDs).

23. The method of claim 20, wherein the first plurality of point light sources is configured to output a first color and the second plurality of point light sources is configured to output a second color.

24. The method of claim 20, wherein the housing includes a gasket configured to be disposed between the outer perimeter of the speaker cone and a speaker covering.

25. The method of claim 24, wherein the housing includes a printed circuit board, and including forming a plurality of conductive traces over the printed circuit board to electrically connect the first and second plurality of point light sources to the control switch.
